(19) United States
(12) Patent Application Publication
(10) Pub. No.: US 2024/0232995 A1
(43) Pub. Date: Jul. 11, 2024

(54) SYSTEM AND METHOD FOR ONLINE STORE USER INTERFACE GENERATION

(71) Applicant: Karma Shopping Ltd., Tel Aviv (IL)

(72) Inventors: Omer GAZIT, Hod HaSharon (IL); Yuval HOCH RONEN, Tel Aviv (IL)

(73) Assignee: Karma Shopping Ltd., Tel Aviv (IL)

(21) Appl. No.: 18/153,149

(22) Filed: Jan. 11, 2023

(51) Int. Cl. G06Q 30/0601

(52) U.S. Cl. CPC G06Q 30/0641

(57) ABSTRACT

A system and method for scraping web pages based on a predetermined web page template is disclosed. The method includes: requesting a first plurality of web pages from a web server, each web page including a markup language document having a first plurality of data fields; determining a web page structure for the first plurality of web pages, wherein a first data field of the first plurality of data fields is matched to a second data field of a second plurality of data fields of a web page template; scraping a second plurality of web pages from the web server based on the determined web page structure; and storing scraped data from the second plurality of web pages in a local cache.

### TECHNICAL FIELD

The present disclosure relates generally to webpage generation, and specifically to generation of webpages based on content from multiple webservers.

### BACKGROUND

The Internet includes content, such as markup language documents, which are displayable on web browser applications. Such content is varied, and the structure of the markup language documents occasionally changes. For example, a website providing news content may have a template markup language document which is used to generate pages based on different content for each page, while keeping a single structure. This is advantageous for both users and publishers of content, as it allows the publishers to reduce the task of formatting, for example, each new content added to a website, and allows a user to more easily find information in a website, as the website's structure serves as a guide to where content can be found.

For example, support ticket systems, ecommerce websites, and other software as a service websites are examples where a template, or structure, is particularly useful as the repeating structure allows a user to easily find the relevant information they are looking for, for any particular page.

Internet content is also useful for use in websites other than the original publisher. One method of obtaining content is by utilizing a scraper. Scrapers are software programs which are configured to retrieve data, content, and the like, from web pages. While dissemination of content is useful, for example for offloading network congestion, scrapers still require network bandwidth, and content providers may be reluctant to provide bandwidth for them. In some cases, scrapers are used to obtain content from a publisher and redistribute it as original content, making publishers all the more reluctant to allow scrapers to access content stored on their website.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for scraping web pages based on a predetermined web page template. The method also includes requesting a first plurality of web pages from a web server, each web page including a markup language document having a first plurality of data fields; determining a web page structure for the first plurality of web pages, where a first data field of the first plurality of data fields is matched to a second data field of a second plurality of data fields of a web page template; scraping a second plurality of web pages from the web server based on the determined web page structure; and storing scraped data from the second plurality of web pages in a local cache. Other embodiments of this aspect include corresponding computer systems, apparatus, and computer programs recorded on one or more computer storage devices, each configured to perform the actions of the methods.

One general aspect includes a non-transitory computer readable medium having stored thereon instructions for causing a processing circuitry to execute a process. The non-transitory computer readable medium also includes requesting a first plurality of web pages from a web server, each web page including a markup language document having a first plurality of data fields; determining a web page structure for the first plurality of web pages, where a first data field of the first plurality of data fields is matched to a second data field of a second plurality of data fields of a web page template; scraping a second plurality of web pages from the web server based on the determined web page structure; and storing scraped data from the second plurality of web pages in a local cache. Other embodiments of this aspect include corresponding computer systems, apparatus, and computer programs recorded on one or more computer storage devices, each configured to perform the actions of the methods.

One general aspect includes a system for scraping web pages based on a predetermined web page template. The system also includes a processing circuitry. The system also includes a memory, the memory containing instructions that, when executed by the processing circuitry, configure the system to: request a first plurality of web pages from a web server, each web page including a markup language document having a first plurality of data fields; determine a web page structure for the first plurality of web pages, where a first data field of the first plurality of data fields is matched to a second data field of a second plurality of data fields of a web page template; scrape a second plurality of web pages from the web server based on the determined web page structure; and store scraped data from the second plurality of web pages in a local cache. Other embodiments of this aspect include corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a client device for receiving customized webpages, utilized to describe an embodiment.

FIG. 2 is an example flowchart of a method for generating requests for near real time data scraping from a web page, implemented according to an embodiment.

FIG. 3 is an example flowchart of a method for generating a web page from data scraped from a plurality of web servers, implemented in accordance with an embodiment.

FIG. 4 is an example flowchart of a method for providing generated web pages based on content requests, implemented in accordance with an embodiment.

FIG. 5 is an example flowchart of a method for scraping a domain, implemented in accordance with an embodiment.

FIG. 6 is an example flowchart of a method for determining a web page structure from scraped data, implemented in accordance with an embodiment.

FIG. 7 is an example schematic diagram of a page server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for scraping web pages based on a predetermined web page template. It is advantageous, in certain embodiments, to scrape data from web pages based on a determined data structure. This allows, for example, to scrape similar pages and populate the data values, for example in a local data store (e.g., local database). The scraped data is then utilized, for example to generate a web page, generate a web page overlay, combinations thereof, and the like. According to an embodiment, a web page structure is determined for a portion of a plurality of web pages for a domain. Based on the determined web page structure, the plurality of web pages are scraped from the domain, and the resulting scraped data is stored and utilized. Utilizing scraped data includes, according to an embodiment, generating a web page based on the scraped data, generating an overlay for a web page based on data scraped from the web page, combinations thereof, and the like.

It is recognized in this regard that a human can access web pages of a domain, for example by requesting them through a web browser application, and determine a data structure of the same. However, a human cannot scrape data from a web page, and furthermore a human cannot reliably and consistently determine a data structure for a plurality of web pages of a domain, across multiple domains, sub-domains, and the like. A data structure may seem similar to another data structure at superficial glance, leading to incorrect data structure determination. This is especially true when dealing with hundreds of thousands of different domains, each having at least one data structure for a plurality of web pages. Furthermore, data structures of web pages (i.e., web page structures) are constantly changing and require constant determination to ascertain if the structure has changed, and if so, how it has changed. A human cannot perform these tasks reliably and consistently, and definitely cannot perform them within the timeframe required to be useful. For example, if it takes a human longer to determine a data structure for web pages than it does to reformat the same web pages to a different data structure, by the time the human has determined the data structure, the data structure may already have changed.

An aspect of the system disclosed herein solves at least the above noted challenges by providing a solution which reliably and consistently applies objective criteria in determining a structure for web pages for a domain, and then scraping the domain based on the determined structure.

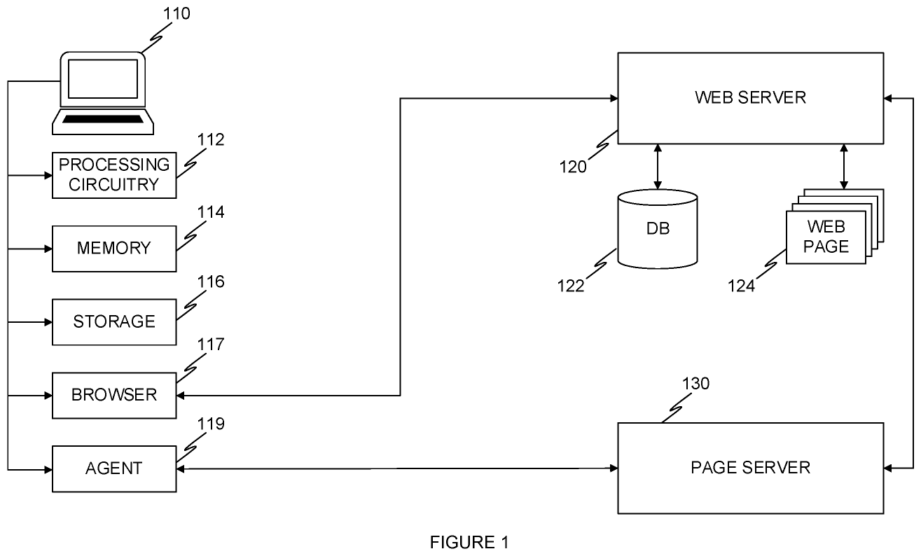

FIG. 1 is an example schematic diagram of a client device for receiving customized webpages, utilized to describe an embodiment. According to an embodiment a client device 110 is a personal computer, a laptop, a smartphone, a tablet, and the like. In an embodiment, the client device 110 includes a processing circuitry 112, a memory 114, a storage 116, and a network interface card (NIC) 118. An example embodiment of a computer architecture for implementing a client device 110 is discussed in more detail below.

In an embodiment, the client device 110 includes a browser software application 117, and an agent software 119. In certain embodiments, the browser software application 117 is configured to request content, such as a web page. A web page includes, in an embodiment, a text, an image, a video, a multimedia content, a combination thereof, and the like. For example, in an embodiment a web page includes a hypertext markup language (HTML) document.

In certain embodiments, a request for web content, a web page, a combination thereof, and the like, is generated by the browser software application 117 (also referred to as browser 117). For example, in an embodiment a user input, such as a textual input, a mouse click, and the like generates a request to fetch content based on a uniform resource locator (URL). In some embodiments, the agent software 119 (also referred to as agent 119) is configured to intercept a request to fetch content. In certain embodiments, the request is implemented, for example, in hypertext transfer protocol (HTTP). For example, a GET request is utilized to fetch content from a URL via HTTP, in accordance with an embodiment.

In an embodiment the browser 117 configures the client device 110 to send the request for content directed to a web server 120. In an embodiment, a web server 120 is implemented as an Nginx® server, an Apache® Web Server, a Google® Web Server, and the like. In some embodiments the web server 120 is configured to provide content. For example, in an embodiment the web server 120 is configured to host a web site, including a plurality of web pages, such as web page 124.

In some embodiments, the web server 120 is configured to generate a web page. For example, in an embodiment the web server 120 includes a database 122, and generates a web page based on a request for content. The generated web page is then provided by the web server 120 to the requesting device (e.g., the client device 110). For example, in an embodiment the database 122 is a relational database, such as a MySQL database. The database 122 includes a table having a plurality of columns.

For example, in an embodiment a first column represents an item name, a second column represents an item sale price, a third column represents an amount of the item in stock, a third column represent a SKU, and the like. In response to receiving a request from the client device 110, the web server 120 is configured to generate a web page based on a row of the database 122. For example, the web server 120 is configured, according to an embodiment, to generate a web page based on a template and data from the database 122. The template includes, in an embodiment, HTML code, Javascript® code, Java® code, a combination thereof, and the like.

In an embodiment, the request for content includes a row identifier, such as a SKU value. The web server 120 is configured, according to an embodiment, to query the database for a row corresponding to the SKU value, and read a value from each column corresponding to a row where the SKU value is detected. For example, where SKU value ‘4312’ is detected in row ‘12’, data from row 12 of the first column, row 12 of the second column, etc. is extracted (e.g., as a result of the query), and utilized by the web server 120 to generate a webpage based on a predetermined table. This allows to dynamically generate web pages as they are needed, and easily update the same as information changes, such as price, availability, and the like.

In some embodiments a page server 130 is configured to communicate with the agent 119 and the web server 120. In an embodiment the page server 130 is implemented as a virtual machine, a software container, a serverless function, a combination thereof, and the like.

In an embodiment, the page server 130 is configured to receive an input from the agent 119 and generate a web page based on the received input. For example, according to an embodiment, the agent 119 is configured to detect a URL in a client device 110 request, and send the URL to the page server 130. In an embodiment, the agent 119 is configured to send a URL to the page server 130 based on an input received from a user of the user device 110.

In certain embodiments, the page server 130 is configured to fetch content from the web server 120 based, for example, on the received URL. In certain embodiments, the page server is configured to generate a web page based on content fetched by the page server 130 from the web server 120.

For example, in an embodiment the page server 130 is configured to fetch content from a plurality of web servers, and generate a single web page based on the content fetched from the plurality of web servers. In certain embodiments the page server 130 is configured to fetch content from a plurality of web servers, and generate a second plurality of web pages based on the fetched content, where the plurality of web servers is more than the plurality of web pages. In some embodiments this is advantageous as it allows a user to receive information from multiple web servers on a single location. Furthermore, where multiple users request the same data from the same web server, it is advantageous to store this information in a page server 130 which is configured to provide the data to each user, thereby offloading a portion of the network traffic from the web servers to the page server 130.

In some embodiments, the page server 130 is configured to detect an access request, for example directed at the web server 120. In an embodiment, an access request includes a URL request directed at a domain, sub-domain, and the like. In certain embodiments, where a number of access requests exceeds a threshold (e.g., determined by storing a counter to count access requests), the page server 130 is configured to initiate scraping of data from the web server 120.

For example, according to an embodiment, the page server is configured to request a first plurality of web pages 124 from the web server 120, and determine therefrom a data structure which is common to the first plurality of web pages. For example, a web page generated for each employee of a company, for each product in a warehouse, and the like, share a data structure which describes the employee or the product, respectively. In an embodiment, a data structure includes a plurality of data fields of a markup language document.

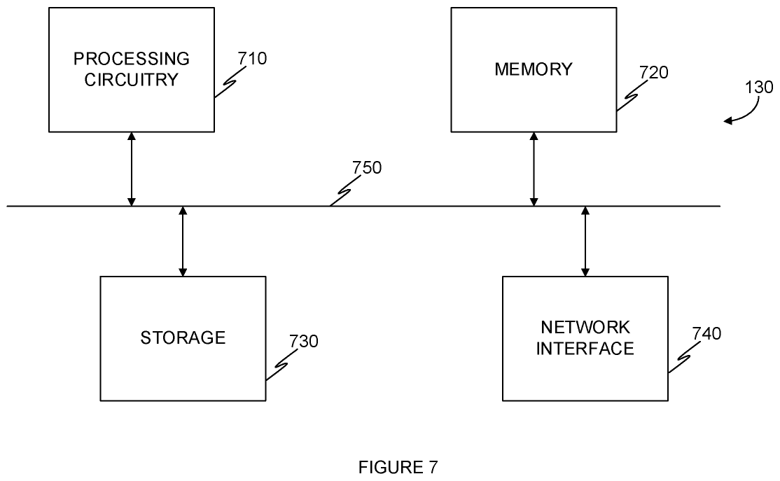

In an embodiment, the page server 130 is further configured to scrape a second plurality of web pages from the web server 120, which include at least a web page which is not a web page of the first plurality of web pages 124. In certain embodiments, the second plurality of web pages are scraped based on the determined data structure. Scraping the second plurality of web pages is discussed in more detail below, and specifically with respect to FIG. 7.

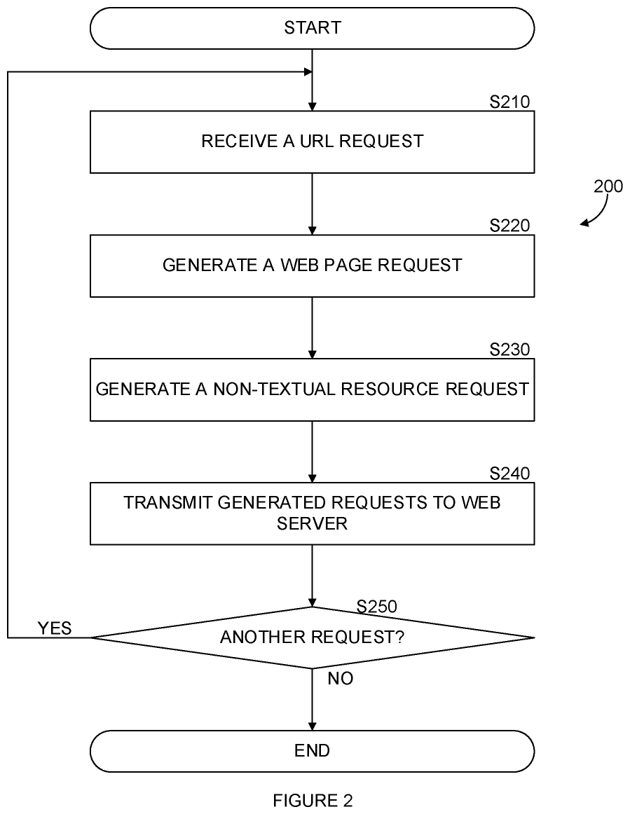

FIG. 2 is an example flowchart of a method for generating requests for near real time data scraping from a web page, implemented according to an embodiment. It is recognized that real time and near real time have different definitions in computing applications and web applications. For the purpose of this disclosure, real time are computer actions such as sending data, receiving data, displaying data, and the like, which occur within a real-time constraint, or otherwise without significant delay. In this regard, significant delay may be measured as impact on user experience, where a user feels that loading a web page is taking too long, usually over two seconds, for example. Near real time is a time frame typically longer than real time, but less than an order of magnitude greater. For example, if real time is up to one second, near real time is less than ten seconds. In an embodiment, near real time is less than five seconds; in other embodiments it is less than three seconds.

At S210, a URL request is received. In an embodiment, the URL request is received over HTTP and includes an HTTP request, such as GET, POST, and the like. In an embodiment the URL request further includes a header which provides metadata on the URL request. The URL request includes a source (e.g., a client device), a destination (e.g., web server), and a resource identifier. A resource identifier may be, for example, a web address, including a host name, domain, path, and the like. In an embodiment, the URL request includes a request for a textual content, such as a web page, and a request for a non-textual content, such as a media file, image file, video file, and the like. In an embodiment, a textual resource is detected in the URL request, and a non-textual resource is detected in the URL request. Detecting a textual resource includes, according to an embodiment, detecting a request for HTML code. Detecting a non-textual resource includes, for example, detecting a request for an image file, video file, stylesheet, and the like, for example in an HTML code.

At S220, a web page request is generated based on the received URL request. In an embodiment, the web page request is a request for receiving a textual resource, for example an HTML based web page. In an embodiment, the web page request may be sent directly to a web server, or through a proxy server. For example, an address of the web server may be determined from the destination field of the received URL request.

At S230, a non-textual resource request is generated based on the received URL request. In an embodiment, the URL request includes requests for text resources, such as web pages, text files, and the like, and requests which are for resources which are not textual, such as image files, video files, media files, and the like. In certain embodiments, requests are split into groups based on their type of content, such as textual and non-textual. In other embodiments, requests are split into groups based on content as textual content, image content, video content, and the like. In an embodiment, textual content is requested through a first network path, while non-textual content is requested through a second path, where the second network path has a latency which is larger than the latency of the first network path.

In certain embodiments, a portion of the non-textual content is filtered out. For example, a JavaScript code, an image, a video, a multimedia, a font, an Ajax request, combinations thereof, and the like, may be filtered out of the non-textual content request. This is advantageous as decreasing the requested content means that a webpage will load faster since the less content is requested the faster a page can load the content which is requested, as the webpage is loaded once all content is received. Content which is filtered out is content for which a request to fetch is not generated.

In some embodiments, the average latency of the first network path is shorter than the average latency of the second network path. In certain embodiments, a plurality of second network paths are utilized, each second network path having a latency which is longer than the latency of the first network path. In some embodiments, a network path includes any one of: a client device (origin endpoint), a scraping server, a proxy server, and a web server (destination endpoint). In certain embodiments, the non-textual resource request is further generated based on a determined latency of a network path, wherein the network path includes the web server as a destination endpoint.

At S240, the generated requests are transmitted. In an embodiment, transmitting a generated request includes sending a generated request based on a network path to a web server. The network path includes, in an embodiment, a proxy server.

At S250, a check is performed to determine if additional URL requests are received. If ‘yes’, execution continues at S210. In some embodiments, if ‘no’ execution may terminate. In certain embodiments, execution continues by scraping received content and generating a new or modified content, which is discussed in more detail below.

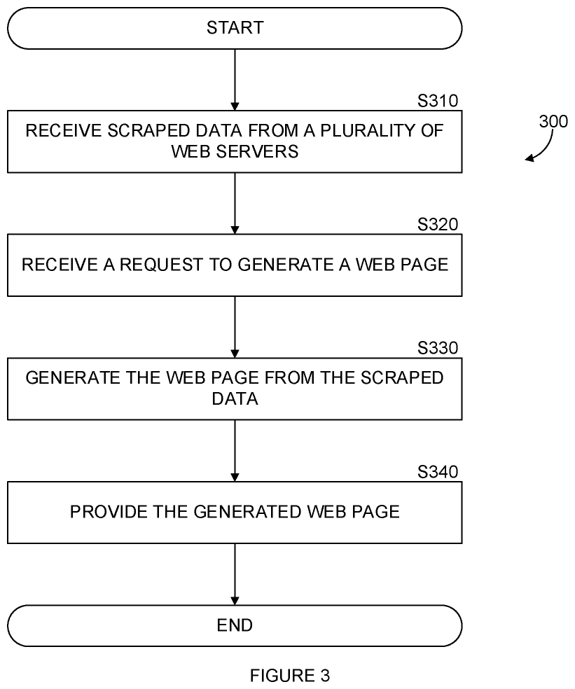

FIG. 3 is an example flowchart of a method for generating a web page from data scraped from a plurality of web servers, implemented in accordance with an embodiment. It is advantageous, according to an embodiment, to scrape data from multiple web servers, where each web server provides different content. This allows generating a new web page from the scraped data which includes data from multiple web servers.

For example, this allows generating a single web page based off of data scraped from a first web server which provides a backend for a website for providing services from a first party, and from a second web server which provides a backend for a website for providing services from a second party, which is unaffiliated with the first party. This is beneficial to a user which now need only navigate to a single web page to receive all the information they desire to consume. Furthermore, this allows for decongesting network traffic, as the user does not access the plurality of webservers directly, but rather accesses only a page server which provides the generated web page.

At S310, scraped data is received from a plurality of web servers. In an embodiment, the data is scraped utilizing the methods described in more detail herein. In some embodiments, scraped data includes a value of a data field, extracted from a markup language document. In certain embodiments, a scraper (e.g., such as the page server 130 of FIG. 1) is configured to request data from each of a plurality of web servers. For example, in an embodiment a web server is configured to send a markup language document in response to receiving a request for a resource from the web server.

At S320, a request is received to generate a web page. In an embodiment, the request is received to generate a web page which includes the scraped data. For example, in an embodiment a web page is generated based on data scraped from a plurality of web servers. In some embodiments, scraped data from each web server is utilized to generate a frame, a tag, and the like, in a markup language document, such as HTML.

At S330, the web page is generated. In an embodiment, the web page is generated based on a template. For example, a template includes a markup language document having a data field which is populated based on the received scraped data. In some embodiments, a plurality of templates are utilized. In certain embodiments, a first plurality of templates are implemented as frames, each of which may be implemented, for example as code, in a second plurality of page templates.

In some embodiments, generating a web page is performed based on scraped data which is stored in a cache. In certain embodiments, the cache includes an eviction policy to evict scraped data which is utilized below a predetermined threshold.

At S340, the generated web page is provided. In some embodiments, providing a web page includes providing a link, URL, URI, and the like, through which the generated web page is accessible to a browser application. In certain embodiments, the generated web page is provided by a plugin communicatively coupled with a browser application, for display on the browser application.

For example, according to an embodiment, the plugin is implemented as a software application, software module, and the like, deployed on a client device having a web browser thereon. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein

In an embodiment, providing the generated web page includes sending the generated web page over a network connection established between a web server and a client device, wherein the web server is configured to generate the web page, and the client device is configured to receive the web page. For example, according to an embodiment, the web page is provided over hypertext transfer protocol (HTTP).

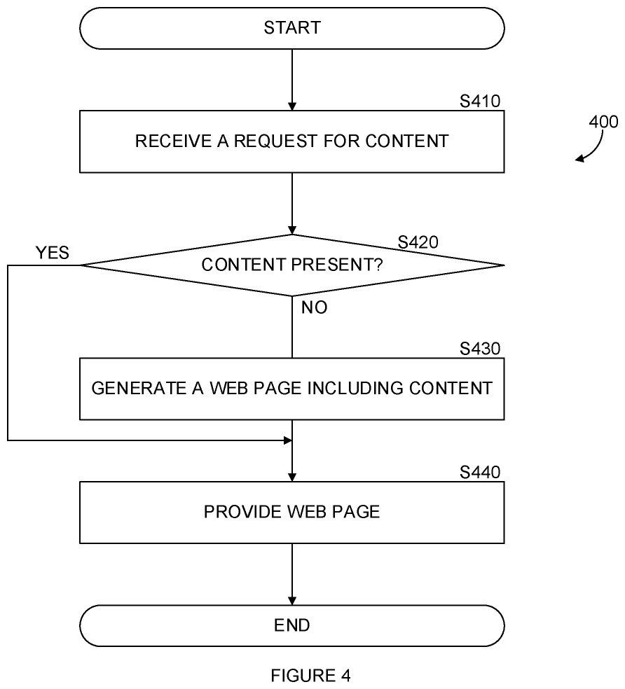

FIG. 4 is an example flowchart 400 of a method for providing generated web pages based on content requests, implemented in accordance with an embodiment.

At S410, a request for content is received. In an embodiment, the request is generated by a client device, for example by a browser application deployed on the client device, and is received by a web server, page server, and the like, which is configured to provide web content therefrom. In certain embodiments, the request includes a content identifier, such as an item number, item name, domain name, IP address, combinations thereof, and the like.

In an embodiment, the content includes scraped data, scraped images, combinations thereof, and the like. In some embodiments, scraped information, including data and images, is utilized in generating a web page based on a template.

At S420, a check is performed to determine if the content is present. In an embodiment, the check is performed respective of a cache memory, storage, and the like temporary storage, to determine if the requested content is stored thereon. In certain embodiments, the check is performed by comparing an identifier of the requested content to an identifier of stored content. In an embodiment, if ‘yes’ execution continues at S440, if ‘no’ execution continues at S430.

At S430, a web page including the content is generated. In an embodiment, the web page is generated based on scraped content. Scraped content (e.g., scraped data, scraped images, etc.) is stored, according to an embodiment, in a cache accessible by a page server configured to generate web pages. In some embodiments, the web page is generated based on a template. In certain embodiments, a frame, a portion of a web page, and the like, is generated based on the content.

For example, in an embodiment, the content includes a SKU, an item description, an item name, and an item price. Each content is represented by a value (e.g., a string, a number, etc.) which is scraped and stored in a cache, according to an embodiment. A template includes, for example, HTML code which is modified, updated, and the like, based on the content. In an embodiment, the template further includes formatting data, which is utilized by a browser to render an HTML page for display.

At S440, the web page including the content is provided. In some embodiments, providing a web page includes providing a link, URL, URI, and the like, through which the generated web page is accessible to a browser application. In certain embodiments, the generated web page is provided by a plugin communicatively coupled with a browser application, for display on the browser application.

In an embodiment, providing the generated web page includes sending the generated web page over a network connection established between a web server and a client device, wherein the web server is configured to generate the web page, and the client device is configured to receive the web page. For example, according to an embodiment, the web page is provided over hypertext transfer protocol (HTTP).

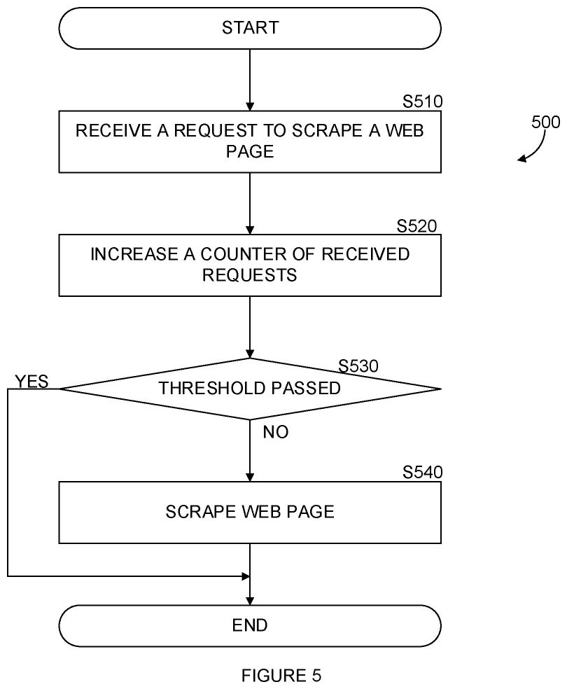

FIG. 5 is an example flowchart of a method for scraping a domain, implemented in accordance with an embodiment. In some embodiments, scraping a domain includes retrieving data from the domain which is utilized in generating another web page (i.e., a web page which is not available from the domain), generating preauthorized database transactions, and the like. For example, in an embodiment data is scraped from a domain periodically. In response to detecting that the scraped data includes a value which matches, exceeds, or is below, a predetermined value (or, in another embodiment, a threshold), a preauthorized database transaction is committed to a database.

For example, in an embodiment, a domain includes a plurality of web pages, each web page directed to a product. In certain embodiments, the web page includes data values such as SKU, a product description, a product name, a product price, and the like. In some embodiments, a database transaction represents a purchase order of a product, for example, to enter into the database a transaction indicating that 100 units of product X are purchased for a price of $1 per unit. In an embodiment, the domain is scraped to detect a web page for product X (e.g., by detecting the identifier ‘X’ of the product in the scraped data), and the web page is periodically scraped to determine a unit price of product X. In some embodiments, a server is configured to commit the database transaction indicating a purchase order in response to detecting from the scraped data a unit price for product X which is at, or below, the predetermined value (i.e., $1).

At S510, a request is received to scrape a web page. In an embodiment, the request is generated in response to detecting a request on a web browser for a URL from a certain domain (e.g., www.example.com). For example, in an embodiment, a plugin is configured to detect URLs requested by a web browser deployed on a client device. In an embodiment, the plugin is further configured to generate an overlay for a web page displayed by the web browser. In some embodiments, the overlay includes a user input field, such as an interactive button (e.g., a graphic that a user can interact with). In certain embodiments, the user input field is utilized for example at S520 below.

At S520, a request counter is increased. In an embodiment, the request counter is configured to count a number of requests for a domain, for a URL within a domain, for a combination thereof, and the like. In some embodiments, the counter is configured with an eviction policy, for example to remove a request, a number of requests, and the like, for example based on a time period (e.g., remove five counts every twenty four hours). In certain embodiments, the counter is configured to reset periodically to a predetermined number, e.g., to zero.

In an embodiment, the counter is increased when a user input is received, for example through a user input field. For example, in an embodiment, a plugin is configured to generate an overlay for a web page displayed on a client device. The overlay includes a user input field, for example an interactive button. In response to receiving an interaction (e.g., the user clicks on the button) as a user input respective of the user input field, the counter is increased, according to an embodiment.

In some embodiments, a counter is stored for each web page of a domain, for each domain, for a plurality of web pages, for a plurality of domains, a combination thereof, and the like.

At S530, a check is performed to determine if a threshold is exceeded. In an embodiment, the threshold is a predetermined threshold. In some embodiments, a first threshold is utilized for a first counter, e.g., a web page counter, and a second threshold is utilized for a second counter, e.g., a domain counter.

In some embodiments, the threshold is a constant threshold, an adaptive threshold, a dynamic threshold, and the like.

At S540, a web page is scraped. In an embodiment, scraping is initiated based on exceeding, meeting, and the like, of a threshold. In an embodiment, scraping is performed for a plurality of web pages, a domain, a plurality of domains, combinations thereof, and the like. In some embodiments, an instruction is generated for scraping a web page, and executed periodically. In certain embodiments, a scraping server is configured to periodically scrape data from web pages based on a generated instruction to scrape.

In some embodiments, a domain is determined to be scraped, for example based on a counter as discussed above. In such embodiments, a plurality of web pages are requested from the domain to determine a page structure. An embodiment of a method for scraping a domain is discussed in more detail herein.

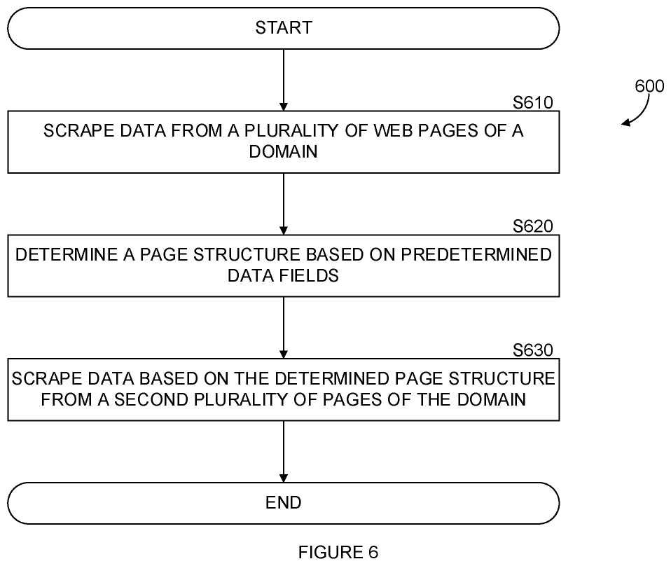

FIG. 6 is an example flowchart of a method for determining a web page structure from scraped data, implemented in accordance with an embodiment. In some embodiments, determining a web page structure is beneficial to determine what data fields should be scraped from a web page. By targeting certain data fields, it is possible to perform data scraping more efficiently, and faster.

At S610, data is scraped from a domain. In an embodiment, data is scraped from each of a plurality of web pages of a domain. In some embodiments, the plurality of web pages are selected from the domain such that they are a portion of a total number of web pages in a domain. For example, in an embodiment ten web pages are selected from the domain for scraping, wherein the domain includes one hundred pages.

In some embodiments, selection of a web page is performed based on a sitemap, a web crawler, combinations thereof, and the like. For example, in an embodiment a sitemap of a domain, subdomain, and the like, is accessed to determine a number of web pages. In some embodiments, a scraping server, such as the page server of FIG. 1 above, is configured to select, for example randomly, a plurality of web pages to scrape. In some embodiments, the same web pages are scraped periodically. In other embodiments, a different plurality of web pages are scraped periodically.

In certain embodiments, a web crawler is configured to crawl a domain to determine a number of web pages, identifiers thereof, and the like. For example, a crawler is configured, according to an embodiment, to detect web pages in a domain, from which a plurality of web pages is selected for scraping.

In an embodiment, scraping a plurality of web pages includes initiating a communication session, for example over the Internet, with a web server, requesting a resource via a URL request, receiving the request resource (including, e.g., text, markup language, images, MIME type, and the like), and storing the result as scraped data.

At S620, a page structure is determined. In an embodiment, a page structure includes data fields, each data field storing a data value. For example, a data field is “usd_price”, in an embodiment, and a value for the data field is “25”. In certain embodiments, a page structure is determined by detecting data fields based on a predefined template. For example, in an embodiment, a template includes a “price” data field, having a numerical value adjacent to a character indicating a currency (e.g., a dollar sign—$). A web page is searched for a data field having a numerical value which is adjacent to a unicode representation of a currency, according to an embodiment. An identifier of the data field is then matched (or mapped) to the data field of the template. In an embodiment, the matching (or mapping) is stored in a lookup table.

In some embodiments, a plurality of page structures are determined. For example, according to an embodiment, a first page structure is determined for a first plurality of web pages of a domain, and a second page structure is determined for a second plurality of web pages of the domain. In certain embodiments, a first page structure is determined for a first sub-domain of a domain, and a second page structure is determined for a second sub-domain of the domain.

In certain embodiments, natural language processing (NLP) techniques are utilized to determine if a data field from a web page and a data field in a web page template relate to the same data field. For example, in an embodiment, a vector distance is determined between two data field identifiers, for example utilizing Word2Vec, to determine if the two data field identifiers relate to the same data (e.g., product name).

At S630, data is scraped from a web page. In an embodiment, data is scraped from a web page of the domain based on the determined page structure. In certain embodiments, the web page is a web page which is not a web page of the plurality of web pages from which the page structure was detected. In some embodiments, the scraped data is stored based on a template web page. For example, in an embodiment, a lookup table is utilized to determine what data fields to search for in the web page. A value of a detected data field is scraped and stored, according to an embodiment, based on a predefined template of a web page.

It is advantageous, in certain embodiments, to scrape data from web pages based on a determined data structure. This allows, for example, to scrape similar pages and populate the data values, for example in a local data store (e.g., local database). The scraped data is then utilized, for example to generate a web page, generate a web page overlay, combinations thereof, and the like.

In some embodiments, a page structure change is detected. For example, in some embodiments, a web page located at a first URL changes, is updated, and the like, from a first page structure to a second page structure. In such embodiments, it is advantageous to again determine a page structure, for example for the domain. In an embodiment, in response to detecting that the page structure is different, based on an initial mapping, execution continues at S620 to determine a new page structure.

In certain embodiments, page structure change is periodically checked for, for example by requesting a web page at a predetermined URL, scraping data based on a previously stored mapping, and determining if a data field value type is the same, is present, and the like. For example, in an embodiment, a data field value type changes from string to integer. In other embodiments, the data field changes position within a page structure (e.g., from a first frame to a second frame within the page).

In some embodiments, a page structure change is detected by comparing a page structure of a web page at first URL at a first time, to a page structure of a web page at the first URL at a second time which is later than the first time. In an embodiment, a first section of a page structure at a first time is compared to a first section of a page structure at a second time, such that the first section at the first time corresponds to the first section at the second time. In some embodiments, a web page from a URL is compared at a first time to a web page from the URL at a second time, wherein the comparison includes comparing data fields (e.g., identifiers of data fields), and without comparing the values of the data fields. This is advantageous as values, such as “price” can change, while the data field itself does not.

FIG. 7 is an example schematic diagram of a page server 130 according to an embodiment. The page server 130 includes a processing circuitry 710 coupled to a memory 720, a storage 730, and a network interface 740. In an embodiment, the components of the page server 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof. In an embodiment, the memory 720 is an on-chip memory, an off-chip memory, a combination thereof, and the like. In certain embodiments, the memory 720 is a scratch-pad memory for the processing circuitry 710.

In one configuration, software for implementing one or more embodiments disclosed herein may be stored in the storage 730, in the memory 720, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 740 is configured to provide the page server 130 with communication with, for example, the web server 120, client device 110, and the like.

It should be understood that the embodiments described herein are not limited to the specific architecture illustrated in FIG. 7, and other architectures may be equally used without departing from the scope of the disclosed embodiments.

Furthermore, in certain embodiments the web server 120, client device 110, and the like, may be implemented with the architecture illustrated in FIG. 4. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for scraping web pages based on a predetermined web page template, comprising:
requesting a first plurality of web pages from a web server, each web page including a markup language document having a first plurality of data fields;
determining a web page structure for the first plurality of web pages, wherein a first data field of the first plurality of data fields is matched to a second data field of a second plurality of data fields of a web page template;
scraping a second plurality of web pages from the web server based on the determined web page structure; and
storing scraped data from the second plurality of web pages in a local cache.

2. The method of claim 1, further comprising:
receiving a request to access content from the web server;
advancing a counter associated with the web server from a first value to a second value which is higher than the first value; and
initiating a request for the first plurality of web pages from the web server in response to determining that the second value exceeds a threshold.

3. The method of claim 1, further comprising:
matching a data field from a web page of the first plurality of web pages to a data field of the web page template utilizing a natural language processing technique.

4. The method of claim 1, further comprising:
scraping the second plurality of web pages to detect data values which correspond to data fields of the determined web page structure.

5. The method of claim 1, further comprising:
storing a mapping of the first data field to the second data field in the local cache.

6. The method of claim 1, further comprising:
storing the scraped data in the local cache, the local cache including a data structure based on the web page template.

7. The method of claim 1, further comprising:
generating a web page based on the stored scraped data.

8. The method of claim 1, further comprising:
generating an overlay for a web page based on the stored scraped data.

9. The method of claim 8, further comprising:
generating an instruction, which when executed by a client device, configures the client device to:
display the web page on a web browser; and
display the overlay over the web page on the web browser.

10. The method of claim 1, further comprising:
periodically scraping the first plurality of web pages and the second plurality of web pages, in response to determining the web page structure.

11. A non-transitory computer readable medium having stored thereon instructions for causing a processing circuitry to execute a process, the process comprising:
requesting a first plurality of web pages from a web server, each web page including a markup language document having a first plurality of data fields;
determining a web page structure for the first plurality of web pages, wherein a first data field of the first plurality of data fields is matched to a second data field of a second plurality of data fields of a web page template;
scraping a second plurality of web pages from the web server based on the determined web page structure; and
storing scraped data from the second plurality of web pages in a local cache.

12. A system for scraping web pages based on a predetermined web page template, comprising:
a processing circuitry; and
a memory, the memory containing instructions that, when executed by the processing circuitry, configure the system to:
request a first plurality of web pages from a web server, each web page including a markup language document having a first plurality of data fields;
determine a web page structure for the first plurality of web pages, wherein a first data field of the first plurality of data fields is matched to a second data field of a second plurality of data fields of a web page template;
scrape a second plurality of web pages from the web server based on the determined web page structure; and
store scraped data from the second plurality of web pages in a local cache.

13. The system of claim 12, wherein the memory contains further instructions that, when executed by the processing circuitry, further configure the system to:
receive a request to access content from the web server;
advance a counter associated with the web server from a first value to a second value which is higher than the first value; and
initiate a request for the first plurality of web pages from the web server in response to determining that the second value exceeds a threshold.

14. The system of claim 12, wherein the memory contains further instructions that, when executed by the processing circuitry, further configure the system to:
match a data field from a web page of the first plurality of web pages to a data field of the web page template utilizing a natural language processing technique.

15. The system of claim 12, wherein the memory contains further instructions that, when executed by the processing circuitry, further configure the system to:
scrape the second plurality of web pages to detect data values which correspond to data fields of the determined web page structure.

16. The system of claim 12, wherein the memory contains further instructions that, when executed by the processing circuitry, further configure the system to:
store a mapping of the first data field to the second data field in the local cache.

17. The system of claim 12, wherein the memory contains further instructions that, when executed by the processing circuitry, further configure the system to:
store the scraped data in the local cache, the local cache including a data structure based on the web page template.

18. The system of claim 12, wherein the memory contains further instructions that, when executed by the processing circuitry, further configure the system to:
generate a web page based on the stored scraped data.

19. The system of claim 12, wherein the memory contains further instructions that, when executed by the processing circuitry, further configure the system to:
generate an overlay for a web page based on the stored scraped data.

20. The system of claim 19, wherein the memory contains further instructions that, when executed by the processing circuitry, further configure the system to:
generate an instruction, which when executed by a client device, configures the client device to:
display the web page on a web browser; and
display the overlay over the web page on the web browser.

21. The system of claim 12, wherein the memory contains further instructions that, when executed by the processing circuitry, further configure the system to:
periodically scrape the first plurality of web pages and the second plurality of web pages, in response to determining the web page structure.
